(19) United States
(12) Patent Application Publication
(10) Pub. No.: US 2014/0176046 A1
(43) Pub. Date: Jun. 26, 2014

(54) APPARATUS AND METHOD FOR CONTROLLING A TERMINAL HAVING A MULTIPLE BATTERY CONFIGURATION

(71) Applicant: PANTECH CO., LTD., Seoul (KR)

(72) Inventors: Won Seok PARK, Seoul (KR); Sang Hun Choi, Seoul (KR)

(73) Assignee: PANTECH CO., LTD., Seoul (KR)

(21) Appl. No.: 14/132,864

(22) Filed: Dec. 18, 2013

(30) Foreign Application Priority Data
Dec. 20, 2012 (KR) 10-2012-0149802

(51) Int. Cl. H02J 7/00

(52) U.S. Cl. CPC H02J 7/0063
USPC 320/103; 320/136; 320/126

(57) ABSTRACT

A terminal includes a first battery to supply power to the terminal if a power level of the first battery is above a first reference threshold, a second battery to supply power to the terminal if the power level of the first battery is below the first reference threshold, and a switch to connect at least one of the first battery and the second battery to power the terminal based on the power level of the first battery, in which the first battery is detachable from the terminal.

### CROSS-REFERENCE TO RELATED APPLICATION

This application claims priority from and the benefit under 35 U.S.C. §119(a) of Korean Patent Application No. 10-2012-0149802, filed on Dec. 20, 2012 the entire disclosure of which is incorporated by reference for all purposes.

### BACKGROUND

1. Field

The following description relates to an apparatus and method for controlling a terminal with a multiple battery configuration.

2. Discussion of the Background

In general, a battery of a portable terminal includes a single cell. Therefore, when the battery is separated from the portable terminal for replacement, the portable terminal may be powered off. By mounting again the charged battery to the portable terminal, and by pushing a power key of the portable terminal, the portable terminal may be driven or operational again. A predetermined amount of time may be used to process a general booting sequence for driving the portable terminal again.

Accordingly, while performing an operation of the portable terminal, such as call and execution of an application, for example, the portable terminal may be powered off for battery replacement and the above operation may be suspended. Also, a predetermined amount of time may be required to drive the portable terminal again.

### SUMMARY

Exemplary embodiments of the present invention provide an apparatus and method for controlling a terminal with a multiple battery configuration.

Additional features of the invention will be set forth in the description which follows, and in part will be apparent from the description, or may be learned by practice of the invention.

Exemplary embodiments of the present invention provide a terminal including a first battery to supply power to the terminal if a power level of the first battery is above a first reference threshold, a second battery to supply power to the terminal if the power level of the first battery is below the first reference threshold, and a switch to connect at least one of the first battery and the second battery to power the terminal based on the power level of the first battery, in which the first battery is detachable from the terminal.

Exemplary embodiments of the present invention provide a terminal including a first battery to supply power to the terminal, a second battery to supply power to the terminal if the first battery is separated from the terminal, and a switch to connect the terminal to the second battery to power the terminal if the first battery is separated from the terminal.

Exemplary embodiments of the present invention provide a method for controlling a terminal having a multiple battery configuration including determining whether a first battery is connected to the terminal, determining whether the first battery has a power level below a reference threshold if the first battery is connected to the terminal, and switching supply of power from the first battery to a second battery if the first battery is not connected to the terminal or determined to have a power level below the reference threshold.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an apparatus to control a terminal having a multiple battery configuration according to an exemplary embodiment of the present invention.

FIG. 2 is a block diagram illustrating a controller of an apparatus to control a terminal having a multiple battery configuration according to an exemplary embodiment of the present invention.

FIG. 3 and FIG. 4 are block diagrams illustrating an apparatus to control a terminal having a multiple battery configuration according to an exemplary embodiment of the present invention.

FIG. 5 illustrates an overcurrent protection circuit of an apparatus to control a terminal having a multiple battery configuration according to an exemplary embodiment of the present invention.

FIG. 6 and FIG. 7 illustrate switches of an apparatus to control a terminal having a multiple battery configuration according to an exemplary embodiment of the present invention.

FIG. 8A is a block diagram illustrating an apparatus to control a terminal having a multiple battery configuration according to an exemplary embodiment of the present invention.

FIG. 8B is a table illustrating an operation of a switch of an apparatus to control a terminal having a multiple battery configuration according to an exemplary of the present invention.

FIG. 9, FIG. 10, and FIG. 11 are block diagrams illustrating an apparatus to control a terminal having a multiple battery configuration according to an exemplary embodiment of the present invention.

FIG. 12A, FIG. 12B, FIG. 13, and FIG. 14 are flowcharts illustrating a method for controlling a terminal having a multiple battery configuration according to an exemplary embodiment of the present invention.

FIG. 15, FIG. 16, and FIG. 17 illustrate user interfaces displayed in a battery replacement mode of an apparatus to control a terminal having a multiple battery configuration according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular exemplary embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, exemplary embodiments will be described with reference to the accompanying drawings.

In a terminal having a structure in which a first or main battery may be detached when it is due for replacement or recharge, the terminal may be powered off since power of the main battery and a power manager (PM) that serves to supply power the terminal are separated from each other. To power on the terminal, the charged main battery may be reattached to the terminal and then proceed with a booting sequence process. The charged main battery may be the recharged main battery that was previously separated from the terminal or a different main battery.

To solve the aforementioned user inconvenience, exemplary embodiments of the present invention disclose an apparatus using an auxiliary or a second battery as well as a main battery to continuously supply power to the terminal even when a main battery of the terminal is detached for recharging or replacement.

Also, exemplary embodiments of the present invention may stably drive a battery cell using an overcurrent protection circuit to reduce a likelihood of incurring an overcurrent that may occur when capacity of the main battery and capacity of the auxiliary battery differ.

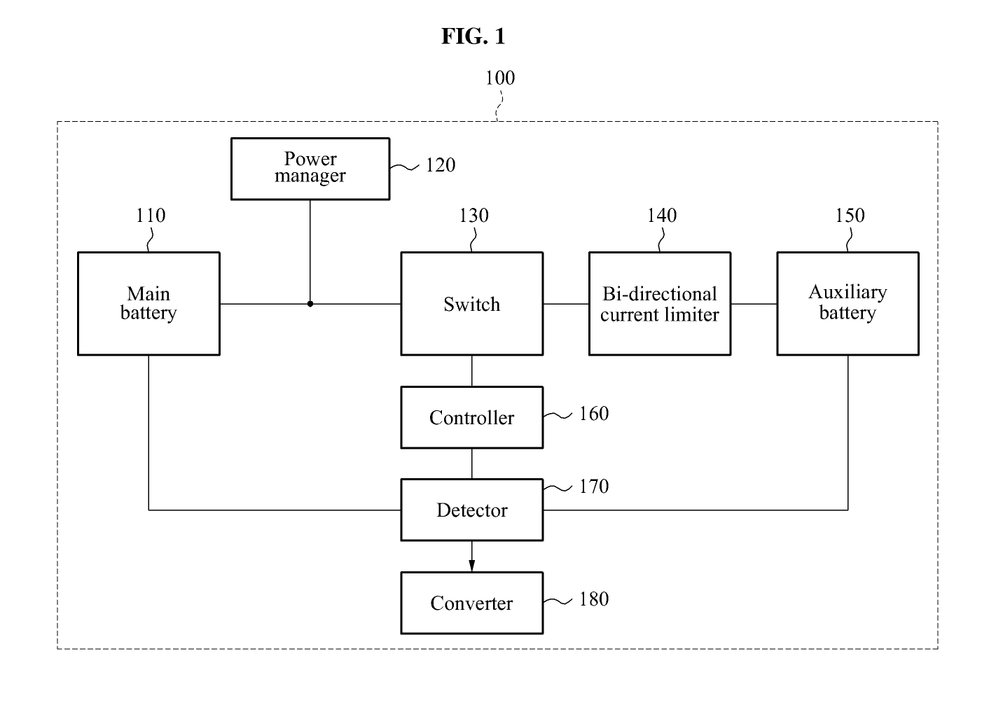

FIG. 1 is a block diagram illustrating an apparatus for controlling a terminal using a dual battery configuration according to an exemplary embodiment of the present invention. Terminal controlling apparatus 100 using a dual battery configuration may be a portable terminal, and may also be a module mounted on the portable terminal. Although the terminal is described as having or using dual battery configuration, aspects of the invention are not limited thereto, such that other multiple battery configurations may be used.

Referring to FIG. 1, the terminal controlling apparatus 100 includes a main or first battery 110, a power manager 120, a switch 130, a bi-directional current limiter 140, an auxiliary or second battery 150, a controller 160, a detector 170, and a converter 180.

The main battery 110 may supply the power manager 120 with power used for driving the terminal. The power manager 120 may manage the power used for driving the terminal. The power manager 120 may transfer or provide power to one or more modules of the terminal.

The switch 130 may electrically connect the main battery 110, the bi-directional current limiter 140, and the auxiliary battery 150. When the auxiliary battery 150 is determined to be used, the switch 130 may electrically connect the auxiliary battery 150 and the main battery 110. Operation of the switch 130 may be controlled based on a control signal of the controller 160. For example, the switch 130 may be turned on or off.

The bi-directional current limiter 140 may limit charge current of the auxiliary battery 150 to be less than or equal to a maximum or reference charge current value of the auxiliary battery 150, and may limit discharge current of the auxiliary battery 150 to be less than or equal to a maximum or reference discharge current value of the auxiliary battery 150.

Capacity of the auxiliary battery 150 may differ from capacity of the main battery 110. The capacity of the auxiliary battery 150 may be less than the capacity of the main battery 110. However, aspects of the invention are not limited thereto, such that the capacity of the auxiliary battery 150 may be same or greater than the capacity of the main battery 110. When the auxiliary battery 150 and the main battery 110 having different capacity are connected, an overcurrent may occur, which may negatively affect quality and lifespan of a battery. The bi-directional current limiter 140 may reduce a likelihood of occurrence of such overcurrent.

When the main battery 110 and the auxiliary battery 150 are connected, the bi-directional current limiter 140 may limit or reduce output current of the main battery 110 to be less than or equal to a maximum or reference charge current value of the auxiliary battery 150. The power manager 120 may be supplied with power from the auxiliary battery 150. Further, the bi-directional current limiter 140 may limit or reduce output current of the auxiliary battery 150 to be less than or equal to a maximum or reference discharge current value of the auxiliary battery 150. For example, when a power level of stored power is less than or equal to a low voltage setting value, the main battery 110 may be supplied with power from the auxiliary battery 150. In this instance, the bi-directional current limiter 140 may also limit the output current of the auxiliary battery 150 to be less than or equal to the maximum discharge current value of the auxiliary battery 150.

The auxiliary battery 150 may have capacity less than the main battery 110, and may supply power to the terminal during separation of the main battery 110 from the terminal. However, aspects of the invention are not limited thereto, such that the auxiliary battery 150 may have the same or greater capacity than the main battery 110. The auxiliary battery 150 may prevent or limit a basic operation of the terminal from being suspended by supplying power to the terminal during separation of the main battery 110. For example, the basic operation may include, without limitation, a calling operation, driving a system program of the terminal, playback of music, and the like.

The controller 160 may control an operation of the switch 130 when charging the auxiliary battery 150 and/or when replacing the main battery 110. For example, when charging the auxiliary battery 150 from power stored in the main battery 110, the controller 160 may turn on the switch 130 to connect the main battery 110 and the auxiliary battery 150. More specifically, the power stored in the main battery 110 may be transferred to the power manager 120 and then be transferred from the power manager 120 to the auxiliary battery 150.

When charging the auxiliary battery 150 from an external charger, the controller 160 may turn off the switch 130. More specifically, the switch 130 may be turned off to charge the main battery 110 using the auxiliary battery 150 but not the external charger.

When charging the auxiliary battery 150 using the main battery 110, which is charged from the external charger, the controller 160 may turn on the switch 130. More specifically, the external charger may charge the main battery 110 but not the auxiliary battery 150.

When replacement main battery 110 is determined to have been installed in the terminal, the controller 160 may turn on the switch 130. The replacement main battery 110 may have a sufficient charge or a charge above a reference threshold to drive the terminal. When a to minimum or reference amount of power used for driving the terminal is supplied from the auxiliary battery 150, the controller 160 may inform that the main battery 110 may be replaced without powering off the terminal. As an example, the controller 160 may display a battery replacement mode enter message on a screen of the terminal. The user may verify the battery replacement mode enter message and may separate the main battery 110, which may be due for replacement or recharge, from the terminal. Since the reference amount of power for driving the terminal is supplied using the auxiliary battery 150 after the main battery 110 is separate from the terminal, the terminal may remain operational in a powered on state.

Further, the controller 160 may inform that replacement of a battery is possible by displaying an image, an icon, and the like on the screen of the terminal. Also, the controller 160 may inform that replacement of a battery is possible by outputting a voice sound, a beep sound, and the like from the terminal.

When reinsertion of the main battery 110 having sufficient charge is detected in the terminal, the controller 160 may turn off the switch 130.

The detector 170 may detect at least one of a power level of the main battery 110, a power level of the auxiliary battery 150, separation of the main battery 110, and reinsertion of the main battery 110. The power level of the main battery 110 may be detected by measuring at least one of a current and voltage flowing in an electric port to and from which the main battery 110 is attached and detached. The power level of the auxiliary battery 150 may be detected by measuring current and voltage flowing in an electric port to which the auxiliary battery 150 is mounted.

Separation and reinsertion of the main battery 110 may be detected based on whether a signal applied to the electric port to and from which the main battery 110 is attached and/or detached. For example, when the current or the voltage is not measured from the electric port, the main battery 110 may be determined to be separate from the terminal. Conversely, when the current or the voltage is measured from the electric port, the main battery 110 may be determined to be inserted into the terminal.

The converter 180 may convert the detected power level of the main battery 110 and power level of the auxiliary battery 150 to a digital number. The converter 180 may convert the detected power level to a value recognizable by the terminal. For example, when the power level is indicated as a voltage value, the converter 180 may convert the detected power level of the main battery 110 to a digital number, such as 4.0 volts (V), for example.

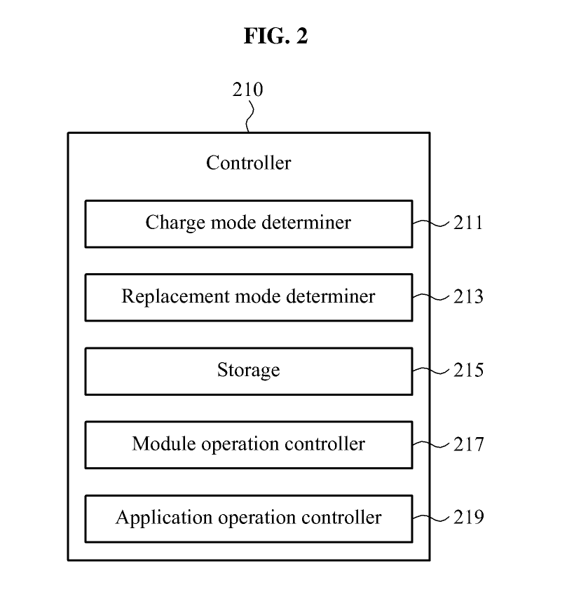

FIG. 2 is a block diagram illustrating a controller of an apparatus to control a terminal having a multiple battery configuration according to an exemplary embodiment of the present invention.

Referring to FIG. 2, the controller 210 includes a charge mode determiner 211, a replacement mode determiner 213, a storage 215, a module operation controller 217, and an application operation controller 219. The controller 210 of FIG. 2 may correspond to the controller 160 of FIG. 1.

The charge mode determiner 211 may determine whether to charge an auxiliary battery based on a power level of the auxiliary battery. For example, the power level of the auxiliary battery may be indicated as a voltage value. When the power level of the auxiliary battery is less than a reference level, such as a charge voltage setting value, of the auxiliary battery, the charge mode determiner 211 may determine to charge the auxiliary battery. The charge voltage setting value may be a reference value indicating that charge of the auxiliary battery is required or recommended.

The charge mode determiner 211 may inform that charge of the auxiliary battery is recommended by displaying at least one of an image, an icon, a message, and the like, on a screen of the terminal.

When a power level of a main battery is greater than a low or reference voltage setting value of the main battery and the charge voltage setting value of the auxiliary battery, the charge mode determiner 211 may determine to charge the auxiliary battery from the main battery. The low voltage setting value of the main battery may refer to a minimum or reference power level at which the main battery may supply power to the terminal.

Further, when insertion of an external charger is detected, the charge mode determiner 211 may determine to charge the auxiliary battery from the external charger. When the external charger does not support charging of the auxiliary battery, the charge mode determiner 211 may determine to charge the auxiliary battery from the main battery by charging the main battery from the external charger.

The replacement mode determiner 213 may determine whether to replace the main battery based on at least one of a power level of the main battery and/or an input of a user. When the power level of the main battery is less than or equal to a low or reference voltage setting value of the main battery, the replacement mode determiner 213 may determine whether to replace the main battery with a main battery with sufficient charge and/or may inform that replacement of a battery is recommended based on the determination result by displaying at least one of an image, an icon, a message, and the like on the screen of the terminal. Further, when a replacement mode setting of the main battery is selected from the user in a reference setting mode on a program of the terminal, the replacement mode determiner 213 may determine to replace the main battery.

When the main battery is determined to be replaced, the storage 215 may store a setting value of a module mounted to the terminal and/or a setting value and data of an application being executed in the terminal. For example, the module may include, without limitation, a communication module, a speaker module, a brightness module of the screen, a camera module, a sensor module, and the like. The setting value of the application may indicate a value set for one or more operations and type of the application during execution of the application.

The module operation controller 217 may control an operation of the module mounted to the terminal based on an amount of power provided from the auxiliary battery. For example, the module operation controller 217 may suspend an operation of the communication module while maintaining other operations of the respective module. For example, the module operation controller 217 may activate only a wireless fidelity (WiFi) operation and may block communication operations using a communication provider network, such as third generation (3G) and long term evolution (LTE), for example. The module operation controller 217 may decrease or turn off a volume of the speaker module. The module operation controller 217 may decrease or turn off a brightness value of the brightness module. The module operation controller 217 may suspend operations of the camera module and the sensor module.

When the charged main battery is reinserted in the terminal, the module operation controller 217 may restore the setting value stored in the storage 215 and may control an operation of the module based on the restored setting value.

The application operation controller 219 may operate, in a standby mode, a remaining application being executed. The application operation controller 219 may operate, in the standby mode, the application in addition to a system program for driving the terminal. When the charged main battery is reinserted, the application operation controller 219 may restore the setting value stored in the storage 215 and may control an operation of the application based on the restored setting value.

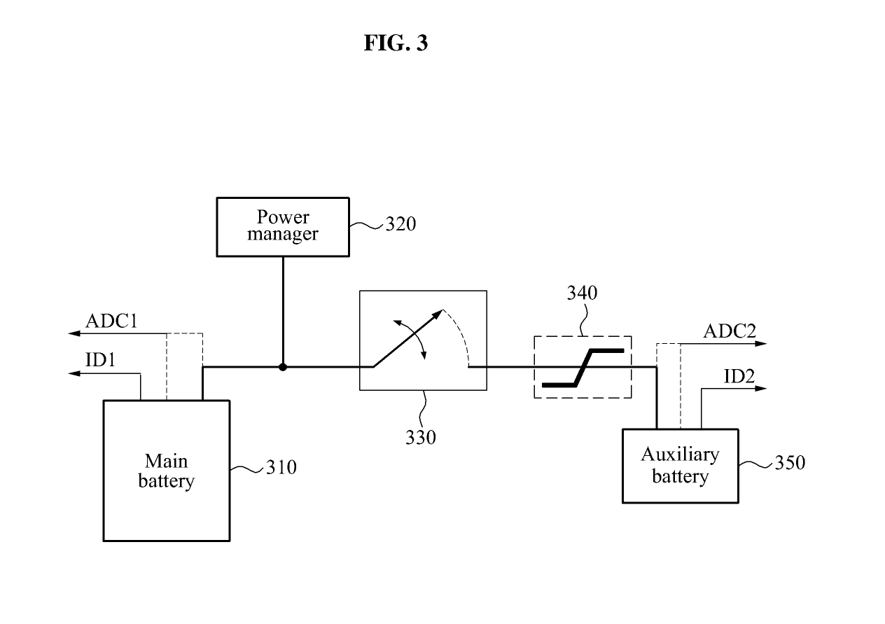

FIG. 3 is a block diagram illustrating an apparatus to control a terminal having a multiple battery configuration according to an exemplary embodiment of the present invention.

Referring to FIG. 3, the terminal controlling apparatus using the dual battery configuration includes a main or first battery 310, a power manager 320, a switch 330, a bi-directional limiter 340, and an auxiliary or second battery 350. Here, the dual battery may indicate a configuration that includes the main battery 310 and the auxiliary battery 350.

The main battery 310 may supply the power manager 320 with power used for driving the terminal. The power manager 320 may manage the power used for driving the terminal. The power manager 320 may transfer power to one or more modules of the terminal. The power manager 320 may also transfer power for charging the auxiliary battery 350 from the main battery 310.

The main battery 310 may be connected to an electric port for identifying whether the main battery 310 is detachable. When the main battery 310 is mounted in the terminal, the electric port may recognize an identification value of ID1. The ID1 value may correspond to a signal applied from the main battery 310 to the electric port that is connected to the main battery 310. The main battery 310 may be connected to a first analog-to-digital converter (ADC1) to detect a power level of the main battery 310. ADC1 may convert a voltage value of the main battery 310 to a power level by digitalizing the voltage value of the main battery 310.

The switch 330 may be turned on when charging the auxiliary battery 350. Also, the switch 330 may be turned on when the main battery 310 is determined is due for replacement. When the charged main battery 310 is reinserted in the terminal, the switch 330 may be turned off. When the auxiliary battery 350 is separately charged from an external charger, the switch 330 may be turned off.

When the switch 330 is turned on, the bi-directional current limiter 340 may limit current supplied from the main battery 310 based on a maximum or reference charge current value of the auxiliary battery 350. When capacity of the main battery 310 and capacity of the auxiliary battery 350 differ, the bi-directional current limiter 340 may protect against or prevent an incurrence of an overcurrent due to a potential difference.

Also, when the power manager 320 is supplied with power from the auxiliary battery 350, the bi-directional current limiter 340 may limit discharge current of the auxiliary battery 350 to be less than or equal to a maximum or reference discharge current value of the auxiliary battery 350. When a voltage value increases to be greater than the maximum or reference discharge current value of the auxiliary battery 350, the auxiliary battery 350 may be damaged.

The auxiliary battery 350 may have capacity less than the capacity of the main battery 310, and may be maintained in an installed state without being separated from the terminal. The auxiliary battery 350 may serve to supply power to the terminal when the main battery 310 is separated from the terminal.

The auxiliary battery 350 may be connected to an electric port for identifying whether the auxiliary battery 350 is mounted. The electric port may recognize an identification value of ID2. The ID2 value may correspond to a signal applied from the auxiliary battery 350 to the electric port that is connected to the auxiliary battery 350. The auxiliary battery 350 may be connected to a second analog-to-digital converter (ADC2) to detect a power level of the auxiliary battery 350. The ADC2 may convert a voltage value of the auxiliary battery 350 to a power level by digitalizing the voltage value of the auxiliary battery 350.

A maximum charge current value and a maximum discharge current value may be defined or set for at least one of the main battery 310 and the auxiliary battery 350. When the maximum charge current value and the maximum discharge current value are exceeded, battery stability issues may arise. Maximum charge current and maximum discharge current of a battery cell may differ, but may be defined within the range of about 1 cell capacity/time (C) to about 2 C. For example, for a battery cell with 200 milliampere-hour (mAh), 1 C may equal to 200 mA.

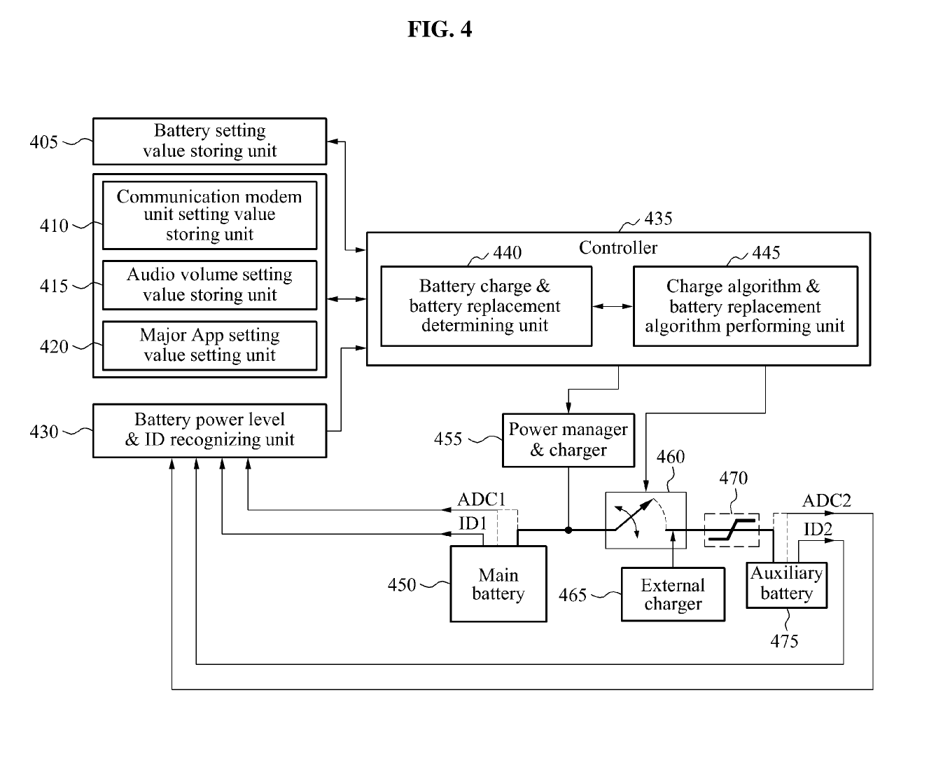

FIG. 4 is a block diagram illustrating an apparatus to control a terminal having a multiple battery configuration according to an exemplary embodiment of the present invention.

Referring to FIG. 4, the terminal controlling apparatus using the dual battery includes a battery setting value storing unit 405, a communication modem unit setting value storing unit 410, an audio volume setting value storing unit 415, an application (App) setting value setting unit 420, a battery power level and ID recognizing unit 430, a controller 435, a main or first battery 450, a power manager and charger 455, a switch 460, an external charger 465, a bi-directional current limiter 470, and an auxiliary or second battery 475.

The battery setting value storing unit 405 may store a charge voltage setting value and a low voltage setting value of the main battery 450, and a charge voltage setting value and a low voltage setting value of the auxiliary battery 475. The charge voltage setting value may be used as a reference value to determine whether to charge a battery, and the low voltage setting value may be used as a reference value to determine whether to supply power from an external source. For example, when a power level of the auxiliary battery 475 is less than or equal to the charge voltage setting value, the auxiliary battery 475 may be due for a recharge. When the power level of the auxiliary battery 475 is less than or equal to the low voltage setting value, the auxiliary battery 475 may not supply power.

The communication modem unit setting value storing unit 410 may store a setting value of a communication module supported by the terminal. For example, the communication modem unit setting value storing unit 410 may store a setting value of a communication module that supports at least one of code division multiple access (CDMA), a global system for mobile communications (GSM), wideband CDMA (WCDMA), long term evolution (LTE), a global positioning system (GPS), wireless fidelity (WiFi), Bluetooth®, and LTE-ad. For example, powering on or off of a currently supportable communication network may be set using a setting value of a communication module. If at least one of CDMA, high speed downlink packet access (HSDPA), LTE, GPS, WiFi, and Bluetooth® are supportable in the communication module, and if LTE and Bluetooth® are currently activated to be received by the communication module, LTE and Bluetooth® may be stored as an active or on-state and remaining CDMA, HSDPA, GPS, and WiFi may be stored as an idle or off-state. Although CDMA, HSDPA, GSM, WCDMA, LTE, a GPS, WiFi, Bluetooth®, and LTE-ad are used examples to describe the communication network, aspects of the invention are not limited thereto. Accordingly, other various communication networks may be supported by the communication module.

When the main battery 450 is determined to be replaced with a main battery 450 or a second main having a sufficient charge, the communication modem unit setting value storing unit 410 may store a setting value of the communication modem corresponding to the determined point in time. When the main battery 450 is determined to be replaced or recharged, the communication module may suspend the currently activated communication network. When the main battery 450 having insufficient charge is replaced with a main battery 450 having sufficient charge, the terminal may load the stored setting value of the communication module and set the loaded setting value as a current setting value of the communication module. Accordingly, the terminal may quickly reuse the setting value of the communication module that has been used before replacing the main battery 450.

For example, when LTE and Bluetooth® are used before replacing the main battery 450 having insufficient charge and LTE and Bluetooth® are stored as an active or on-state, the terminal may preferentially activate LTE and Bluetooth® among communication networks supportable in the communication module, more specifically, among pre-stored setting values, when the main battery 450 having insufficient charge is replaced a main battery 450 with sufficient charge. Although a user does not passively select a communication network, an existing using communication network may be automatically reset.

The audio volume setting value storing unit 415 may store a volume setting value of a speaker module. The speaker module may be used to adjust a volume of sound output from the terminal. The audio volume setting value storing unit 415 may store a volume setting value of the speaker module, for example, a volume value of sound in response to a manual input of a terminal user. In response to a request for storing a volume setting value, the audio volume setting value storing unit 415 may store the volume setting value of the speaker module.

When the main battery 450 is determined to have insufficient charge and due for a replacement or recharge, the audio volume setting value storing unit 415 may store the volume setting value of the speaker module. Further, when the main battery 450 is determined to be due for a replacement or recharging, the speaker module may decrease the volume or may mute the sound of the speaker module. When the main battery 450 is determined to be due for a replacement or recharge, the terminal may store, in the audio volume setting value storing unit 415, a sound setting value of a point in time when the replacement is determined.

For example, when the volume setting value is divided or classified into ten levels, and is set to level 3 when the main battery 450 is determined is due for a replacement or recharge, the volume setting value may be stored as level 3. When the main battery 450 is replaced with another main battery with sufficient charge or a charge above a reference threshold, the terminal may call the volume setting value stored in the audio volume setting value storing unit 415 and may set the called volume setting value as a volume setting value of the speaker module. A volume setting value set by the user may automatically be set again as the volume setting value of the speaker module when the main battery 450 is replaced completed.

The App setting value setting unit 420 may store a setting value of an application being executed. For example, the setting value of the application may be diverse for one or more application types. For a music playback application, the setting value may include at least one of a setting value of an equalizer, a list of songs set as favorite music, a playback speed, and the like. For a radio playback application, the setting value may include frequency information of a radio channel being played back. An application may indicate an application program that may be executable in the terminal. Also, when the main battery 450 is determined have insufficient charge to be due for a replacement or recharge, the App setting value setting unit 420 may also store a list of applications being executed, aside from one or more application programs used for driving the terminal at a reference point in time.

The battery power level and identification (ID) recognizing unit 430 may identify an identification value of ID1 of the main battery 450 based on current or voltage applied from the main battery 450. More specifically, the battery power level and ID recognizing unit 430 may identify ID1 of the main battery 450 based on whether the main battery 450 is attached or detached to the terminal. Also, the battery power level and ID recognizing unit 430 may measure a power level of the main battery 450 based on the voltage applied from the main battery 450, and may indicate the power level of the main battery 450 as a numerical value through analog-to-digital conversion.

The battery power level and ID recognizing unit 430 may identify identification value of ID2 of the auxiliary battery 475 based on current or voltage applied from the auxiliary battery 475. Also, the battery power level and ID recognizing unit 430 may measure a power level of the auxiliary battery 475 based on the voltage applied from the auxiliary battery 475, and may indicate the power level of the auxiliary battery 475 as a numerical value through analog-to-digital conversion.

The controller 435 may control one or more operations of the power manager and charger 455 and the switch 460 when charging the auxiliary battery 475 and/or when replacing the main battery 450.

The controller 435 may include a battery charge and battery replacement determining unit 440 and a charge algorithm and battery replacement algorithm performing unit 445.

The battery charge and battery replacement determining unit 440 may determine whether to charge the auxiliary battery 475 based on a power level of the auxiliary battery 475. The battery charge and battery replacement determining unit 440 may determine whether to charge the auxiliary battery 475 from the main battery 450 or whether to charge the auxiliary battery 475 from the external charger 465. In an example, the external charger 465 may be a charger exclusive to charging the auxiliary battery 475 or the main battery 450.

The battery charge and battery replacement determining unit 440 may determine whether to the main battery 450 has insufficient charge and due for a replacement with a main battery having a sufficient charge. For example, when a power level of the main battery 450 is less than or equal to a low or reference voltage setting value, the battery charge and battery replacement determining unit 440 may determine to replace the main battery 450 with a main battery 450 having a sufficient charge or a different main battery having a sufficient charge. Further, when a selection of a battery replacement mode is inputted from the user, the battery charge and battery replacement determining unit 440 may determine that the main battery 450 is due for replacement.

When charge of the auxiliary battery 475 is determined, the charge algorithm and battery replacement algorithm performing unit 445 may generate a control signal according to a charge algorithm. When the main battery 450 is determined to be due for replacement, the charge algorithm and battery replacement algorithm performing unit 445 may generate a control signal according to a replacement algorithm.

When the auxiliary battery 475 is charged from the main battery 450, the charge algorithm and battery replacement algorithm performing unit 445 may generate a control signal to operate the power manager and charger 455 and to turn on the switch 460.

When the auxiliary battery 475 is charged from the external charger 465, the charge algorithm and battery replacement algorithm performing unit 445 may generate a control signal to turn off the switch 460.

When the main battery 450 is determined to be replaced, the charge algorithm and battery replacement algorithm performing unit 445 may generate a control signal to turn on the switch 460. When the auxiliary battery 475 is connected to the power manager and charger 455, the charge algorithm and battery replacement algorithm performing unit 445 may generate a signal indicating that separation of the main battery 450 is possible.

The main battery 450 may supply the power manager and charger 455 with power for driving the terminal. The power manager and charger 455 may manage the power used for driving the terminal. The power manager and charger 455 may transfer the power used for driving for one or more modules of the terminal. The power manager and charger 455 may be supplied with the power from the main battery 450 and/or may charge the auxiliary battery 475.

The switch 460 may be generally in a turn-off state to maintain operation of the main battery 450 and the auxiliary battery 475 to be in a separate state.

The external charger 465 may be used to charge the auxiliary battery 475.

The bi-directional current limiter 470 may limit charge current of the auxiliary battery 475 to be less than or equal to a maximum or reference charge current value of the auxiliary battery 475, and may limit discharge current of the auxiliary battery 475 to be less than or equal to a maximum or reference discharge current value of the auxiliary battery 475. Accordingly, the bi-directional current limiter 470 may protect or prevent the occurrence of overcurrent when the auxiliary battery 475 is charged from the main battery 450.

The auxiliary battery 475 may have capacity less than capacity of the main battery 450 and may be maintained in an installed state without being separated from the terminal. The auxiliary battery 475 may serve to supply power to the terminal when the main battery 450 is separated from the terminal.

An ADC for measuring voltage of the main battery 450 and an ADC for measuring voltage of the auxiliary battery 475 may measure voltage of the respective batteries. Further, a multiplexer (MUX) may be used. The multiplexer may receive a voltage value from each of the main battery 450 and the auxiliary battery 475 and measure a power level by selecting one of the input voltage values and inputting the selected input value into one of the ADCs. Here, the ADC may be embedded within a main processor or a power management module (PMIC) or may be individually configured.

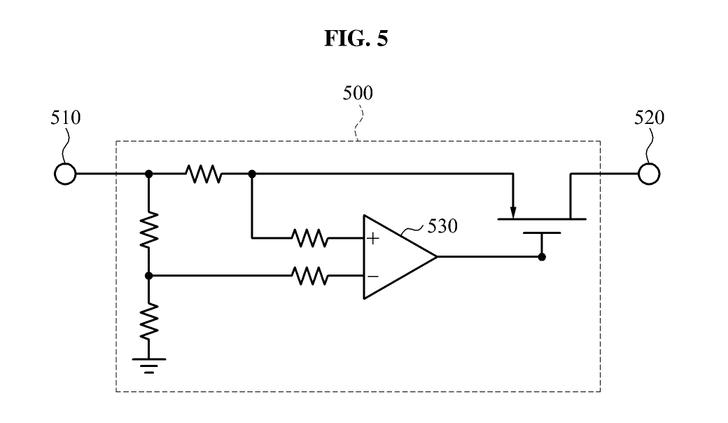

FIG. 5 illustrates an overcurrent protection circuit 500 of an apparatus to control a terminal having a multiple battery configuration according to an exemplary embodiment of the present invention.

Referring to FIG. 5, an input end 510 and an output end 520 of the overcurrent protection circuit 500 may be connected between a main battery and an auxiliary battery that are disposed in the terminal.

The overcurrent protection circuit 500 illustrates a structure of a general current limiter or regulator. Magnitude of current flowing in from a conducting wire may be controlled by comparing a potential difference between the input end 510 and the output end 520 or a potential difference between both ends of a metal-oxide semiconductor field effect transistor (MOSFET) using a comparator 530 and by controlling on/off state of the MOSFET using the output thereof.

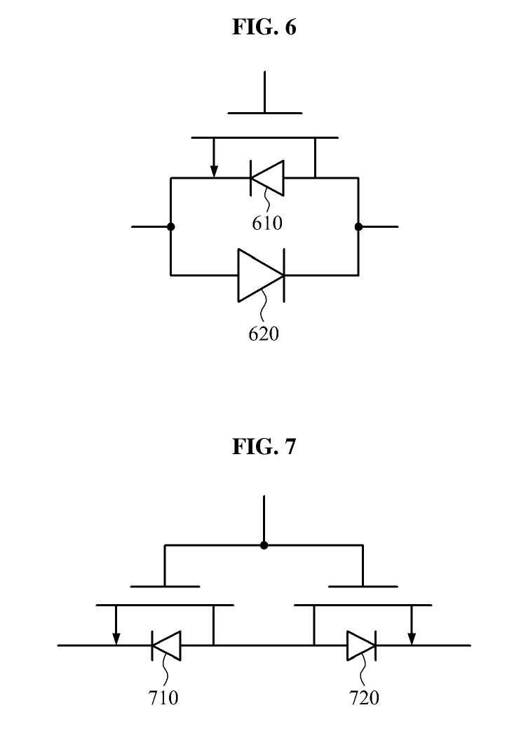

FIG. 6 and FIG. 7 illustrate switches of an apparatus to control a terminal having a multiple battery configuration according to an exemplary embodiment of the present invention.

Referring to FIG. 6, the switch includes a first diode 610 and a second diode 620. The switch of FIG. 6 may include the first diode 610 and the second diode 620 at both ends of a MOSFET in parallel. Further, the switch may flow voltage through the first diode 610 and the second diode 620 when on-voltage of a diode or more is applied to both ends of the MOSFET, and may limit or prevent current from flowing when on-voltage of a diode or less is applied.

The second diode 620 may connect a main battery and an auxiliary battery in a forward direction. When a potential difference between the main battery and the auxiliary battery is greater than or equal to on-voltage of the second diode 620, current may flow from the main battery to the auxiliary battery.

The first diode 610 and the second diode 620 may be connected in parallel and connect the main battery and the auxiliary battery in a backward direction. When voltage of the auxiliary battery is greater than voltage of the main battery by on-voltage of the second diode 610, current may flow from the auxiliary battery to the main battery.

Referring to FIG. 7, the switch may include a first diode 710 and a second diode 720.

The switch of FIG. 7 has a configuration in which a MOSFET is disposed back to back. In such back-to-back configuration of MOSFET, it may be possible to limit or prevent parasitic effects of a diode on the MOSFET, thereby potentially limiting, reducing, or preventing flow of parasitic diode current.

In addition to a switch structure of FIG. 7, the switch may be configured as various types of electronic circuits, such as a MOSFET and a bipolar junction transistor (BJT), and may be configured as an electronic device capable of opening or shorting potential of both ends.

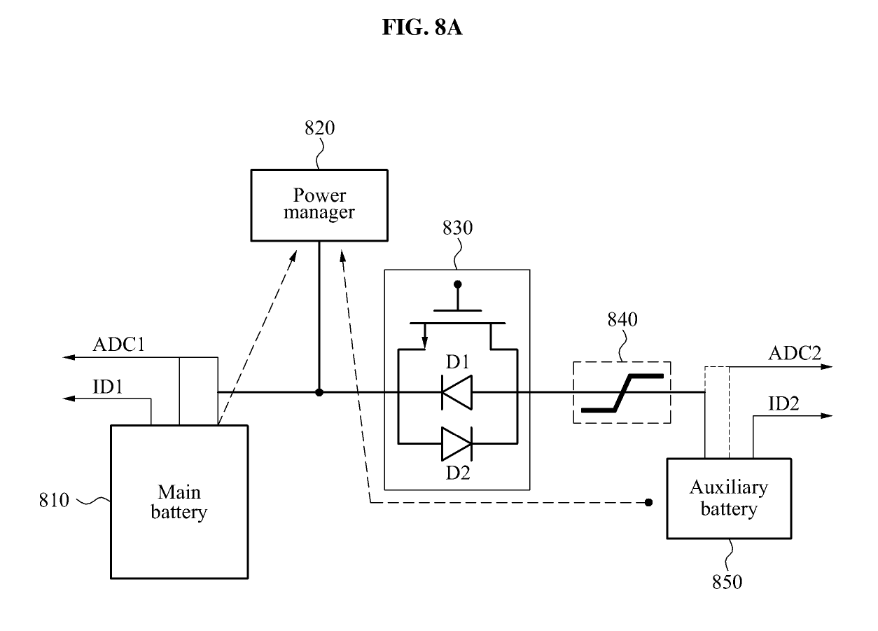

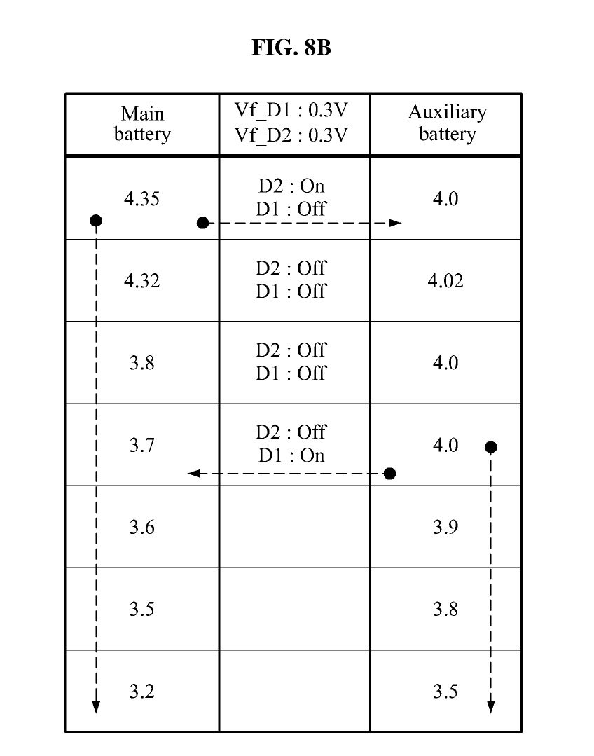

FIG. 8A is a block diagram illustrating an apparatus to control a terminal having a multiple battery configuration according to an exemplary embodiment of the present invention. FIG. 8B is a table illustrating an operation of a switch of an apparatus to control a terminal having a multiple battery configuration according to an exemplary of the present invention.

Referring to FIG. 8A, a power manager 820 may control an operation of the switch 830 by verifying or determining a power level of a main battery 810 and/or a power level of an auxiliary battery 850.

When the power level of the main battery 810 is greater than the power level of the auxiliary battery 850 by on-voltage of diode D2 or more, the switch 830 may be turned on. Current may flow from the main battery 810 to the auxiliary battery 850 to charge the auxiliary battery 850. When a potential difference between the main battery 810 and the auxiliary battery 850 becomes equal to the on-voltage of diode D2, flow of current may be suspended.

Further, when the power level of the auxiliary battery 850 is greater than the power level of the main battery 810 by on-voltage of diode D1 or more, the switch 830 may be turned on. Current may flow from the auxiliary battery 850 to the main battery 810. When the potential difference between the auxiliary battery 850 and the main battery 810 becomes equal to the on-voltage of diode D1, flow of current may be suspended.

The bi-directional current limiter 840 may limit current flowing from the main battery 810 to the auxiliary battery 850 to be less than or equal to a maximum or reference charge current value of the auxiliary battery 850. Also, the bi-directional current limiter 840 may limit current flowing from the auxiliary battery 850 to the main battery 810 to be less than or equal to a maximum or reference discharge current value of the auxiliary battery 850. The bi-directional current limiter 840 may control flow of current to prevent or limit overcurrent when current flows due to a potential difference between the main battery 810 and the auxiliary battery 850.

When a charge voltage level of the auxiliary battery 850 is set to be less than the on-voltage of diode D1, the auxiliary battery 850 may be charged to have voltage less than the on-voltage of diode D1. Accordingly, the switch 830 may be turned on in a forward direction of diode D2. The auxiliary battery 850 may be charged until the power level of the auxiliary battery 850 reaches a value obtained by deducting the on-voltage of diode D2 from the power level of the main battery 810 through current supplied from an external charger or the main battery 810.

Referring to FIG. 8B, on-voltage of each of diode D1 and diode D2 may have a value of 0.3 volts (V). On-voltage of a diode may be variously set based on a type of a diode.

When a power level of the main battery 810 is 4.35V and a power level of the auxiliary battery 850 is 4V, the diode D1 may be turned off since it is forward potential and the diode D2 may be turned on due to a potential difference greater than the on-voltage. For example, the potential difference may be 4.35−4=0.35V. The diode D2 may be turned on and charge current may flow from the main battery 810 to the auxiliary battery 850 to thereby charge the auxiliary battery 850 until the on-voltage becomes equal to the potential difference between the main battery 810 and the auxiliary battery 850.

Also, the main battery 810 may supply power to the power manager 820 based on an amount of current used by the terminal and thus, the power level of the main battery 810 may gradually decrease by an amount of power used.

When load current of the terminal is used until the main battery 810 of the terminal reaches 3.7V, potential of the auxiliary battery 850 may be higher than turn-on voltage of the diode D1 and charge current may flow from the auxiliary battery 850 to the main battery 810. Such operation may be maintained until the main battery 810 enters into a low power consumption state.

When insufficient power of the main battery 810 may be charged from the auxiliary battery 850, charge capacity of the auxiliary battery 850 may supplement the insufficient capacity of the main battery 810.

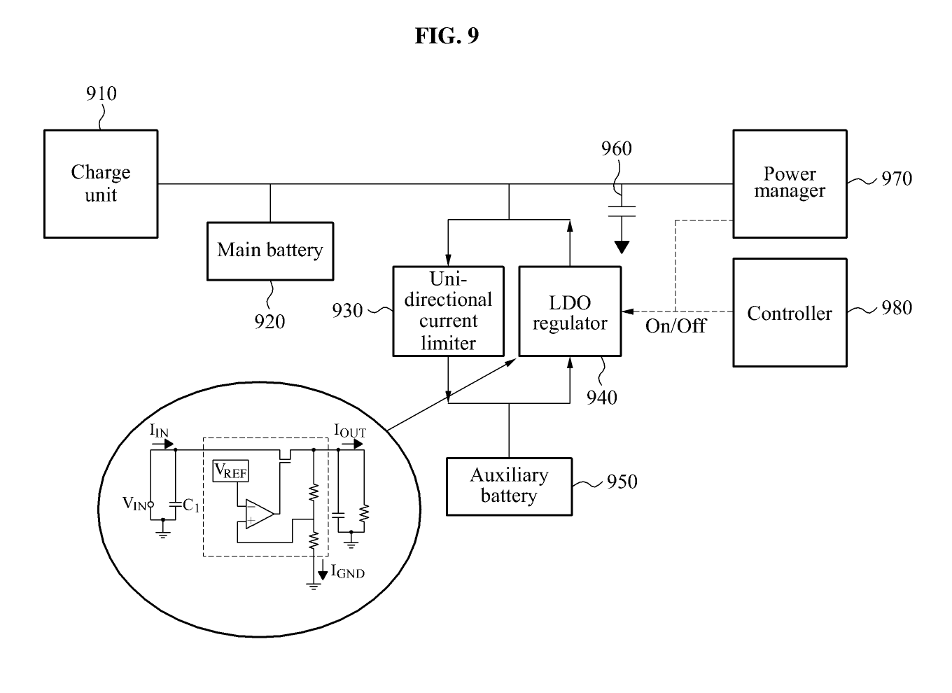

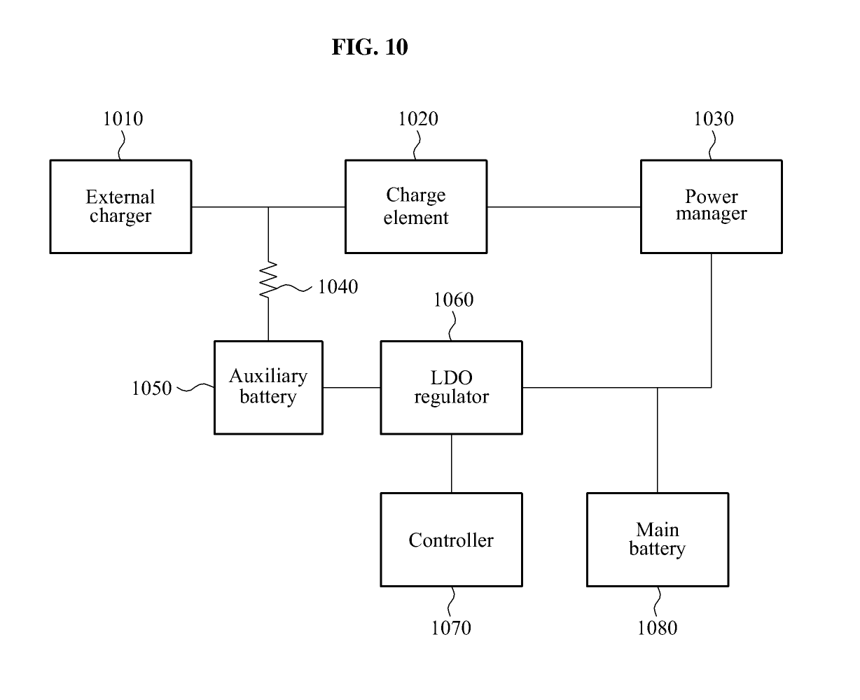

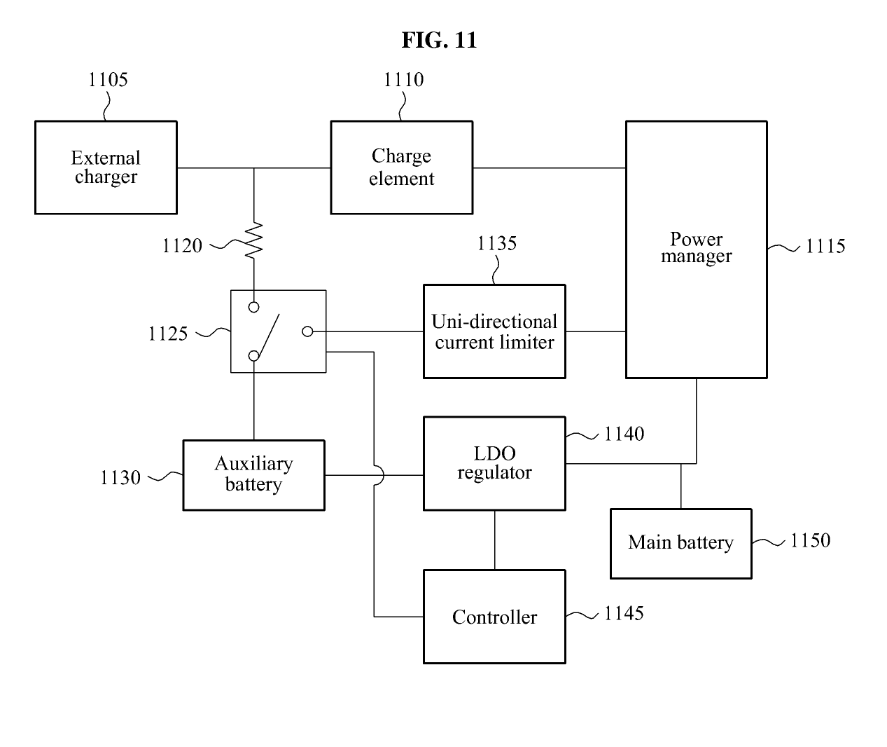

FIG. 9, FIG. 10, and FIG. 11 are block diagrams illustrating an apparatus to control a terminal having a multiple battery configuration according to an exemplary embodiment of the present invention.

Referring to FIG. 9, the terminal controlling apparatus having a multiple battery configuration may include a charge unit 910, a main battery 920, a uni-directional current limiter 930, a low drop output (LDO) regulator 940, an auxiliary battery 950, a capacitor 960, a power manager 970, and a controller 980.

The charge unit 910 may charge the main battery 920 and the auxiliary battery 950. The auxiliary battery 950 may be charged by the power manager 970 through power transferred from the charge unit 910 to the power manager 970.

The main battery 920 may supply the power manager 970 with power for driving the terminal. The power manager 970 may manage power used for driving the terminal. The power manager 970 may also transfer power used for driving for one or more modules of the terminal.

The uni-directional current limiter 930 may limit charge current of the auxiliary battery 930 to be less than or equal to a reference threshold or a maximum charge current value of the auxiliary battery 950. The uni-directional current limiter 930 may limit or prevent overcurrent that may occur due to a capacity difference between the main battery 920 and the auxiliary battery 950.

The LDO regulator 940 may limit or prevent output voltage of the auxiliary battery 950 when the main battery 920 is mounted to the terminal. When the main battery 950 is separated from the terminal, the LDO regulator 940 may convert the outputted voltage of the auxiliary battery 950 to driving voltage of the terminal. Further, the LDO regulator 940 may output the converted driving voltage to the terminal during separation of the main battery 920 from the terminal. For example, when the main battery 920 is separate from the terminal, current may flow from the auxiliary battery 950 to the power manager 970.

An output voltage level of the LDO regulator 940 may be set to be less than a low voltage setting value of the main battery 920. Accordingly, when the main battery 920 is separated from the terminal, the LDO regulator 940 may output the output voltage to the terminal.

The auxiliary battery 950 may have capacity less than the main battery 920 and may supply the power to the terminal during separation of the main battery 920 from the terminal.

The capacitor 960 may be connected at a rear end of the LDO regulator 940 and may smooth or normalize the power supplied to the terminal while the main battery 920 is separated from the terminal and/or while the power is being supplied from the LDO regulator 940. More specifically, the output voltage of the LDO regulator 940 may be applied to the capacitor 960 to store the power in the capacitor 960. The power manager 970 may be supplied with the power from the capacitor 960 to be supplied with smoothed or normalized power having small ripples or variances.

The controller 980 may generate an activation signal capable of turning on or off the LDO regulator 940.

A configuration of FIG. 9 illustrates applying the bi-directional current limiter (e.g., bi-directional current limiter 140 of FIG. 1), which may be further configured as a simple circuit by applying the uni-directional current limiter 930 and the LDO regulator 940. A circuit indicated within a circle of FIG. 9 illustrates a general structure of the LDO regulator 940.

Amount of current in the auxiliary battery 950 maybe controlled by the uni-directional current limiter 930 and thus, the auxiliary battery 950 may be protected from overcurrent. Here, the LDO regulator 940 may not be operational.

When the main battery 920 is determined to be due for replacement, the LDO regulator 940 may be turned on in response to an activation signal of the controller 980 and the LDO regulator 940 may output the power at the set voltage.

By setting an output power level of the LDO regulator 940 to be less than a low voltage setting value of the main battery 920, output power of the LDO regulator 940 may be output when the main battery 920 is separated from the terminal by the user. The above operation applies when output voltage of the LDO regulator 940 is set to be less than a low power level of the main battery 920. Further, a comparator within the LDO regulator 940 operates when a voltage level of an output node is less than internal reference voltage of the LDO regulator 940.

When the user does not separate the main battery 920 from the terminal, output voltage of the LDO regulator 940 is equal to voltage of the main battery 920 and becomes to be greater than the internal reference voltage of the LDO regulator 940. Further, although an activation signal is received, output of the comparator within the LDO regulator 940 may enable a switch within the LDO regulator 940 to be in an off state and thus, voltage may not be output from the LDO regulator 940.

When the user separates the main battery 920 from the terminal, output power of the LDO regulator 940 may be applied to the power manager 970 to maintain the power of the terminal.

When the user reinserts the main battery 920, which has been recharged to have a reference charge value, into the terminal, the terminal controlling apparatus may recognize that the main battery 920 having a sufficient charge is reinserted based on voltage applied from the main battery 920 and may turn off an activation signal of the LDO regulator 940 to turn off the output of the LDO regulator 940.

Referring to FIG. 10, the terminal controlling apparatus having a multiple battery configuration may include an external charger 1010, a charge element 1020, a power manager 1030, resistance 1040, an auxiliary battery 1050, an LDO regulator 1060, a controller 1070, and a main battery 1080.

The external charger 1010 may charge the auxiliary battery 1050. Charge current supplied from the external charger 1010 may be attenuated to be less than or equal to an upper threshold or maximum charge current value of the auxiliary battery 1050 through the resistance 1040 to flow in the auxiliary battery 1050. The resistance 1040 may operate as a uni-directional current limiter.

During a process of transferring power to the power manager 1030, the charge element 1020 may control power charged in a constant current (CC) mode and a constant voltage (CV) mode.

The power manager 1030 may manage power used for driving the terminal. The power manager 1030 may transfer power used for driving for one or more modules of the terminal. The power manager 1030 may charge the main battery 1080 through power supplied from the external charger 1010.

The LDO regulator 1060 may limit or prevent output voltage of the auxiliary battery 1050 when the main battery 1080 is mounted to the terminal. When the main battery 1080 is removed, the LDO regulator 1060 may convert the outputted voltage of the auxiliary battery 1050 to driving voltage of the terminal and output the converted driving voltage to the terminal. More specifically, when the main battery 1080 is separated from the terminal, the current may flows from the auxiliary battery 1050 to the power manager 1030. However, aspects of the invention are not limited thereto, such that the current may flow from the auxiliary battery 1050 to the power manager 1030 when the main battery 1080 has a charge below a reference threshold.

The controller 1070 may generate an activation signal capable of switching the LDO regulator 1060 to an on-state or an off-state.

Referring to FIG. 11, the terminal controlling apparatus having a multiple battery configuration may include an external charger 1105, a charge element 1110, a power manager 1115, resistance 1120, a switch 1125, an auxiliary battery 1130, a uni-directional current limiter 1135, an LDO regulator 1140, a controller 1145, and a main battery 1150. The main battery 1150 may have differing charge values during usage, such that the main battery 1150 having a charge value below a reference threshold may be due for replacement with a charged main battery 1150 having a charge above the reference threshold. However, aspects of the invention are not limited thereto, such that the main battery 1150 due for replacement may be replaced with a different main battery having a sufficient charge or a charge above the reference threshold.

When the external charger 1105 is connected through the switch 1125, the external charger 1105 may charge the auxiliary battery 1130. Charge current supplied from the external charger 1105 may be attenuated to be less than or equal to a maximum charge current value of the auxiliary battery 1130 through the resistance 1120 to flow in the auxiliary battery 1130. The resistance 1120 may operate as a uni-directional current limiter.

Further, when the switch 1125 is connected to the uni-directional current limiter 1135, the external charger 1105 may charge the auxiliary battery 1130 through the power manager 1115.

During a process of transferring the power to the power manager 1115, the charge element 1110 may control power charged in a CC mode and a CV mode.

Charge current for charging the auxiliary battery 1130 at the power manager 1115 may be attenuated to be less than or equal to the maximum or upper threshold charge current value of the auxiliary battery 1130 through the uni-directional current limiter 1135 to flow in the auxiliary battery 1130. The power manager 1115 may charge the main battery 1150 through power supplied from the external charger 1105.

The auxiliary battery 1130 may be directly charged from the external charger 1105 and may also be charged through the power manager 1115.

The LDO regulator 1140 may limit or prevent output voltage of the auxiliary battery 1130 when the main battery 1150 is mounted to the terminal. When the main battery 1150 is separated from the terminal, the LDO regulator 1140 may convert the outputted voltage of the auxiliary battery to driving voltage and output the converted driving voltage to the terminal. More specifically, when the main battery 1150 is separated from the terminal, the current may flow from the auxiliary battery 1130 to the power manager 1115. However, aspects of the invention are not limited thereto, such that the current may flow from the auxiliary battery 1130 to the power manager 1115 when the main battery 1150 has a charge below a reference threshold.

The controller 1145 may generate a signal to control whether to connect the switch 1125 to the resistance 1120 or whether to connect the switch 1125 to the uni-directional current limiter 1135. Also, the controller 1145 may generate an activation signal for turning on or off the LDO regulator 1140.

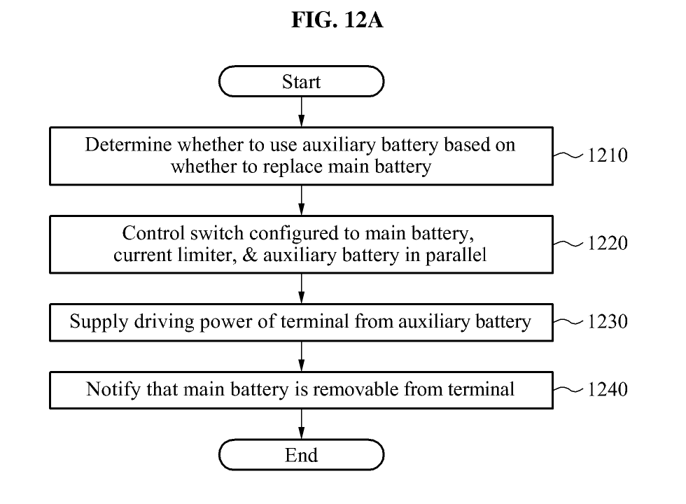

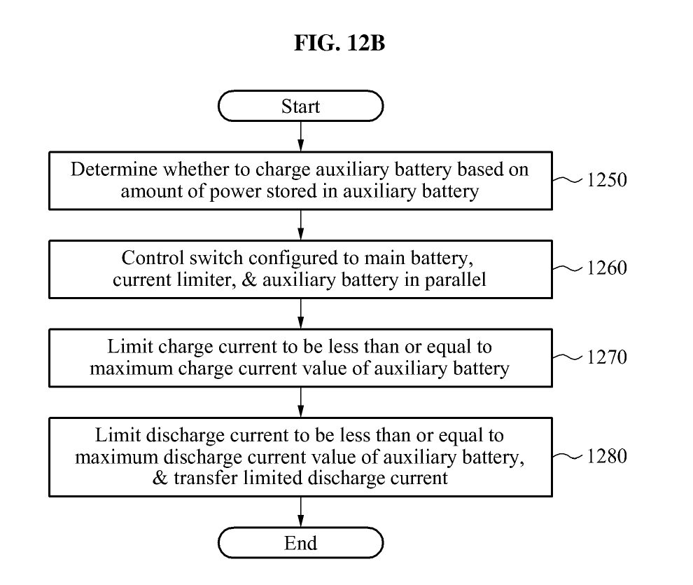

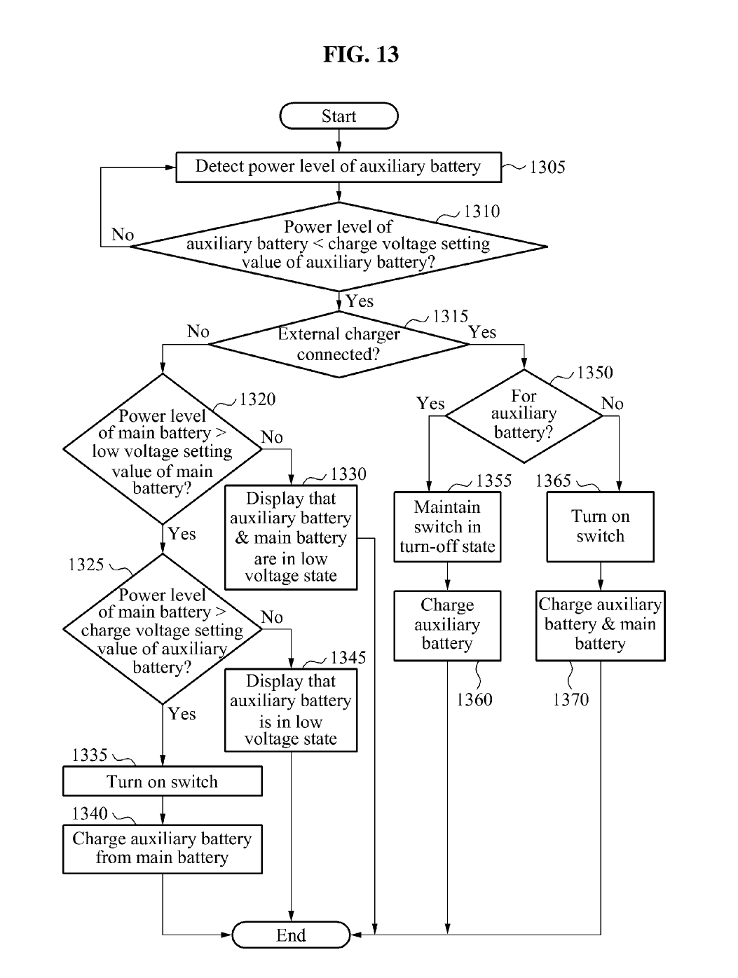

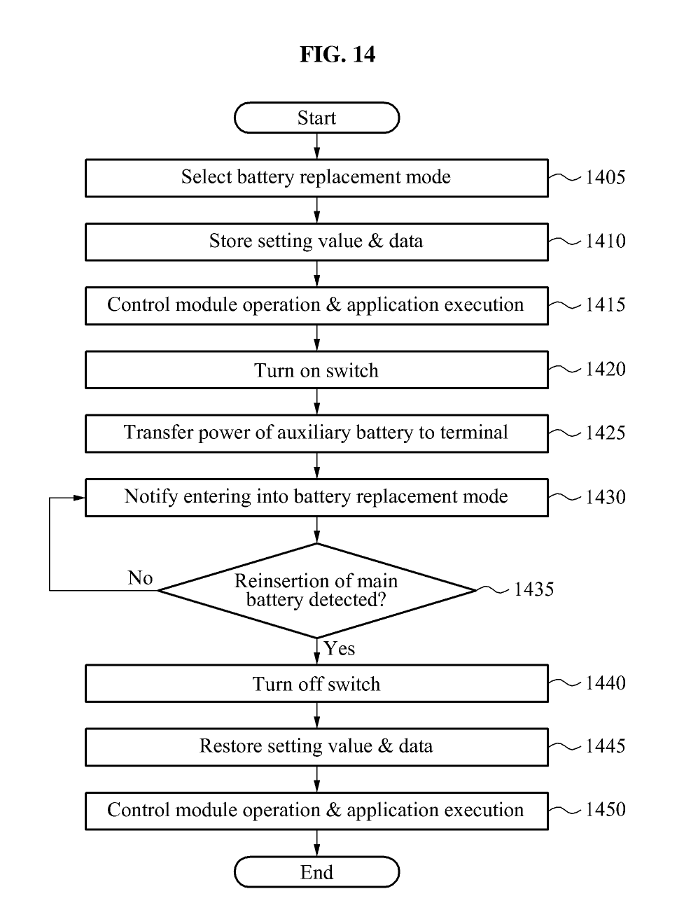

FIG. 12A, FIG. 12B, FIG. 13, and FIG. 14 are flowcharts illustrating a method for controlling a terminal having a multiple battery configuration according to an exemplary embodiment of the present invention.

FIG. 12A is a flowchart illustrating a method for replacing a main battery at a terminal controlling apparatus having a multiple battery configuration according to an exemplary embodiment of the present invention.

Referring to FIG. 12A, in operation 1210, the terminal controlling apparatus may determine whether to use an auxiliary battery based on a determination as to whether the main battery may be due for a replacement or a recharge. The terminal controlling apparatus enables power of the terminal to be continuously maintained using the auxiliary battery during separation of the main battery from the terminal. Further, charge capacity of the auxiliary battery may be less than capacity of the main battery. However, aspects of the invention are not limited thereto, such that the charge capacity of the auxiliary battery may be equal to or greater than the capacity of the main battery, which may be detachable. Further, auxiliary battery may also be detachable from the terminal.

The terminal controlling apparatus may determine to replace the main battery in response to a selection input of a battery replacement mode setting in the terminal. A battery replacement mode may be selected in a terminal setting mode. When the battery replacement mode is selected from a user, a process for replacing the main battery may proceed.

The terminal controlling apparatus may store a setting value of a module mounted to the terminal and a setting value of an application being executed in the terminal before the main battery is separated from the terminal.

The terminal controlling apparatus may control an operation of a module and the execution scheme of the application when the main battery is separated or not connected from the terminal. The auxiliary battery may be used during the separation of the main battery from the terminal. The capacity of the auxiliary battery may less than the capacity of the main battery. Further, when the main battery is separated or not connected from the terminal, the terminal controlling apparatus may suspend an operation of one or more modules, such as a communication module, may decrease volume of a speaker, may decrease a brightness of a screen, and/or the like. Also, the terminal controlling apparatus may set the terminal, and/or one or more applications other than system programs for driving the terminal to be in a standby or idle mode.

In operation 1220, the terminal controlling apparatus may control a switch configured to connect the main battery, a current limiter, and the auxiliary battery in parallel based on a determination of whether to use the auxiliary battery. When the auxiliary is determined to be used, the terminal controlling apparatus may connect the main battery, the current limiter, and the auxiliary battery in parallel by turning on the switch.

In operation 1230, when the main battery, the current limiter, and the auxiliary battery are connected in parallel, the terminal controlling apparatus may supply the terminal with driving power of the terminal from the auxiliary battery. The driving power of the terminal may be provided from the auxiliary battery to a power management module for managing the power of the terminal.

In operation 1240, when the driving power supply of the terminal from the auxiliary battery starts, the terminal controlling apparatus may notify that the main battery may be removed from the terminal. The notification may be displayed on the screen using at least one of a text, an icon, an animation, and the like. Further, the notification may be outputted using vibration or sound.

FIG. 12B is a flowchart illustrating a method for charging an auxiliary battery at a terminal controlling apparatus having a multiple battery configuration according to an exemplary embodiment of the present invention.

Referring to FIG. 12B, in operation 1250, the terminal controlling apparatus may determine whether to charge the auxiliary battery based on an amount of power stored in the auxiliary battery.

For example, when a power level of the auxiliary battery is less than a charge voltage setting value of the auxiliary battery and the power level of the main battery is greater than a charge voltage setting value of the auxiliary battery, the terminal controlling apparatus may charge the auxiliary battery from the main battery. A power level of the main battery may be greater than the low voltage setting value of the main battery.

When the power level of the auxiliary battery is less than the charge voltage setting value of the auxiliary battery and an external charger is inserted into the terminal, the terminal controlling apparatus may charge the auxiliary battery through power supplied from the external charger.

In operation 1260, the terminal controlling apparatus may control a switch configured to connect the main battery, the current limiter, and the auxiliary battery in parallel, based on a determination of whether to charge the auxiliary battery. When charge of the auxiliary battery is determined, the terminal controlling apparatus may connect the main battery, the current limiter, and the auxiliary battery in parallel by turning on the switch.

In operation 1270, the terminal controlling apparatus may limit charge current, flowing from the main battery to the auxiliary battery, to be less than or equal to a maximum or upper threshold charge current value of the auxiliary battery using the current limiter. Overcurrent that may occur due to a difference between the capacity of the main battery and the capacity of the auxiliary battery may be limited or prevented by the current limiter.

In operation 1280, the terminal controlling apparatus may limit discharge current of the auxiliary battery to be less than or equal to an upper threshold or a maximum discharge current value of the auxiliary battery using the current limiter. By limiting a discharge current value of the auxiliary battery using the current limiter, it may be possible to reduce or limit decrease in lifespan of the auxiliary battery due to overcurrent.

FIG. 13 is a flowchart illustrating a method for performing a charge control algorithm of an auxiliary battery in a method for controlling a terminal having a multiple battery configuration according to an exemplary embodiment of the present invention.

In operation 1305, a terminal controlling apparatus having a multiple battery configuration may detect a power level of the auxiliary battery. The power level of the auxiliary battery may be detected by measuring voltage of the auxiliary battery.

In operation 1310, the terminal controlling apparatus may determine whether the power level of the auxiliary battery is less than a charge voltage setting value of the auxiliary battery.

When the power level of the auxiliary battery is determined to be less than the charge voltage setting value of the auxiliary battery, the terminal controlling apparatus may determine whether an external charger is connected in operation 1315.

When the external charger is determined not to be connected, the terminal controlling apparatus may determine whether the power level of the main battery is greater than a low voltage setting value of the main battery in operation 1320.

When the power level of the main battery is greater than the low voltage setting value of the main battery, the terminal controlling apparatus may determine whether the power level of the main battery is greater than the charge voltage setting value of the auxiliary battery in operation 1325.

When the power level of the main battery is less than or equal to the low voltage setting value of the main battery, the terminal controlling apparatus may indicate that both the auxiliary battery and the main battery are in a low voltage state in operation 1330. The notification may be displayed on a screen of the terminal using at least one of an image, an icon, a message, and the like.

When the power level of the main battery is greater than the charge voltage setting value of the auxiliary battery, the terminal controlling apparatus may connect the main battery and the auxiliary battery by turning on the switch in operation 1335.

In operation 1340, the terminal controlling apparatus may charge the auxiliary battery from the main battery. Current supplied from the main battery may be limited to be less than or equal to the upper threshold or maximum charge current value of the auxiliary battery using the current limiter.

When the power level of the main battery is less than or equal to the charge voltage setting value of the auxiliary battery, the terminal controlling apparatus may indicate that the auxiliary battery is in a low voltage state in operation 1345. The notification may be displayed on the screen of the terminal using at least one of an image, an icon, a message, and the like.

When the external charger is determined to be connected, the terminal controlling apparatus may determine whether the external charger is used for the auxiliary battery in operation 1350. Further, the terminal controlling apparatus may determine whether the external charger is exclusively used for the auxiliary battery. Whether the external charger is exclusive for the auxiliary battery may be determined based on an identifier (ID) of the external charger.

Whether the external charger is inserted into the terminal may be determined by a method of recognizing a universal serial bus (USB) ID defined in a general USB standard, a method of recognizing electrical short of a USB D+ signal and D-signal, and/or any other types of recognition methods.

When the external charger is determined to be used for charging the auxiliary battery, the terminal controlling apparatus may maintain a turn-off state of the switch in operation 1355. More specifically, when the external charger is determined to be used for charging the auxiliary battery, the main battery and the auxiliary battery may not be connected.

In operation 1360, the terminal controlling apparatus may charge the auxiliary battery through the external charger.

When the external charger is determined not to be used for charging the auxiliary battery, the terminal controlling apparatus may turn on the switch in operation 1365.

In operation 1370, the terminal controlling apparatus may charge the auxiliary battery through the main battery that is charged from the external charger. Current supplied from the main battery may be limited to be less than or equal to an upper threshold or a maximum charge current value of the auxiliary battery using the current limiter.

FIG. 14 is a flowchart illustrating a method for performing a replacement control algorithm of a main battery in a method for controlling a terminal having a multiple battery configuration according to an exemplary embodiment of the present invention.

In operation 1405, a terminal controlling apparatus having a multiple battery configuration may receive a selection input of a battery replacement mode from a user.

In operation 1410, the terminal controlling apparatus may store a setting value and data of a module mounted to the terminal. The terminal controlling apparatus may store a setting value of an application being executed and relevant data.

In operation 1415, the terminal controlling apparatus may control an operation of the module and execution of the application based on charge capacity of the auxiliary battery. Since the capacity of the auxiliary battery is less than capacity of the main battery, the terminal may limit its operations. Accordingly, the terminal controlling apparatus may suspend the operation of one or more modules and enable the application to enter into a standby mode.

In operation 1420, the terminal controlling apparatus may connect the main battery, a current limiter, a power manager, and the auxiliary battery by turning on a switch.

In operation 1425, the terminal controlling apparatus may transfer, to the terminal, power stored in the auxiliary battery. More specifically, the power stored in the auxiliary battery may be transferred to the power manager. Also, overcurrent occurring due to a difference between the capacity of the main battery and the capacity of the auxiliary battery may be limited or prevented by the current limiter.

When power supply from the auxiliary battery to the terminal starts, the terminal controlling apparatus may display an indication of entering into a battery replacement mode on a screen of the terminal in operation 1430. The notification may be displayed on the screen of the terminal using at least one of an image, an icon, and a message. Further, the notification may be performed using a sound or vibration operation of the terminal.

In operation 1435, the terminal controlling apparatus may determine whether the main battery having a charge above a reference threshold is reinserted in the terminal after its separation therefrom. The terminal controlling apparatus may determine whether the main battery is reinserted based on a voltage value of an electric port connected to the main battery.

When reinsertion of the main battery is detected, the terminal controlling apparatus may turn off the switch in operation 1440. For example, the terminal controlling apparatus may suspend the power supply from the auxiliary battery to the terminal.

In operation 1445, the terminal controlling apparatus may restore the stored setting values and data of the module and the application.

In operation 1450, the terminal controlling apparatus may control the operation of the module and may execute the application based on the restored setting values and data.

When replacing the main battery, load current may be considered to handle the power used in the terminal using only the auxiliary battery. A small portion of the auxiliary battery may be used for maintaining a limited operation of the terminal. When the size of the auxiliary battery decreases, cell charge capacity and allowable maximum or threshold charge current may have trade-off relationship. Accordingly, the load current may be controlled not to exceed a threshold or a maximum discharge current tolerance value of the auxiliary battery.

Capacity of a small auxiliary battery with a size applicable to a portable terminal may not manage operational current of the general portable terminal and thus, a battery replacement mode capable of maintaining a threshold or a minimum power amount may be used when replacing the main battery.

The battery replacement mode may be set in a power menu or another menu of a portable terminal. Without limitation, the portable terminal may include a smart phone, a portable electronic device, a laptop, a portable gaming or display device, and the like. When setting the battery replacement mode, it may be possible to temporarily suspend or turn off an operation of a communication modem unit that uses a larger amount of power in the portable terminal.

Also, a power consumption amount may be decreased by decreasing, minimizing, or turning off a liquid crystal display (LCD) backlight and a speaker volume. Accordingly, it may be possible to limit or prevent exceeding a threshold or a maximum charge/discharge tolerance current value of the small auxiliary battery. Also, aside from a system program used for maintaining power of the terminal, an application that is currently active or operating on background may be set to enter a standby mode.

When entering into a battery replacement mode, the switch may be turned on and the auxiliary battery may supply power to the terminal together with the main battery. When the notification indicating entering into the battery replacement mode is displayed, the user may replace the main battery.

It may be possible to separately display a message or a notice indicating successful entry into the battery replacement mode. When entering the battery replacement mode is sufficiently fast, the above notification may not be provided.

When the user reinserts the charged main battery into the terminal, the reinsertion of the main battery may be detected by sensing an identification signal of the main battery or by measuring an increase value of voltage of a battery. When the reinsertion of the main battery is detected, the switch may be turned off again.

An ID port may be used when, as an electric port applied to an existing battery in order to classify battery capacity, an ADC reads a distributed voltage level of an ID electric port and determines the read voltage level as one of large capacity, medium capacity, and small capacity. When a voltage value indicating a capacity value of greater than or equal to small capacity is detected while a level of the ID electric port is in a low state or has a value of 0, or when a high interrupt signal is inputted to an application processor by connecting the ID terminal to the application terminal, the terminal controlling apparatus may detect that the main battery is in a reinserted state.

In an initial stage, the switch may be maintained in an off state so that the terminal may be normally powered off and then rebooted when the user separates the main battery from the terminal without entering into the battery replacement mode when the terminal is in an unpredicted malfunction state.

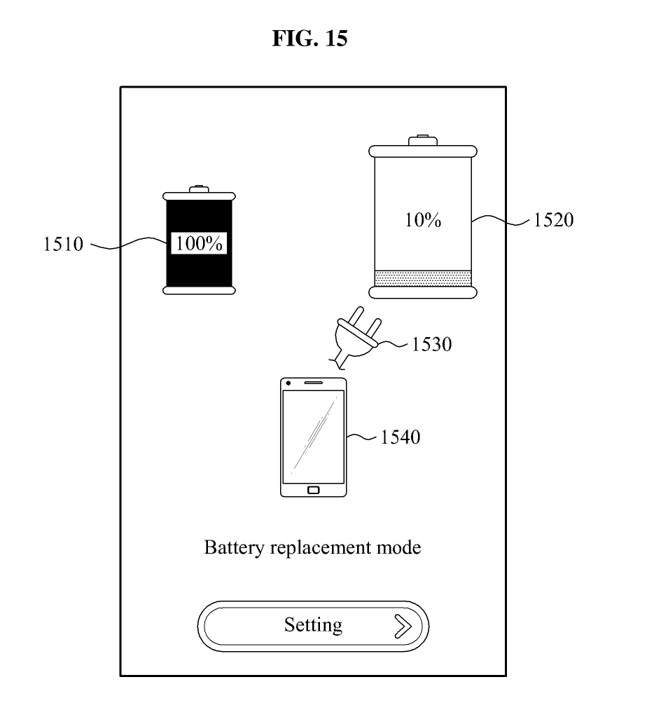

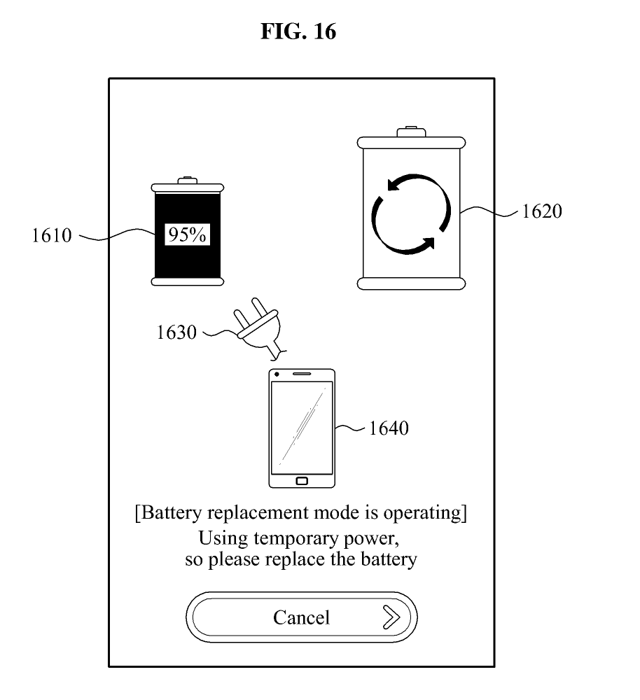

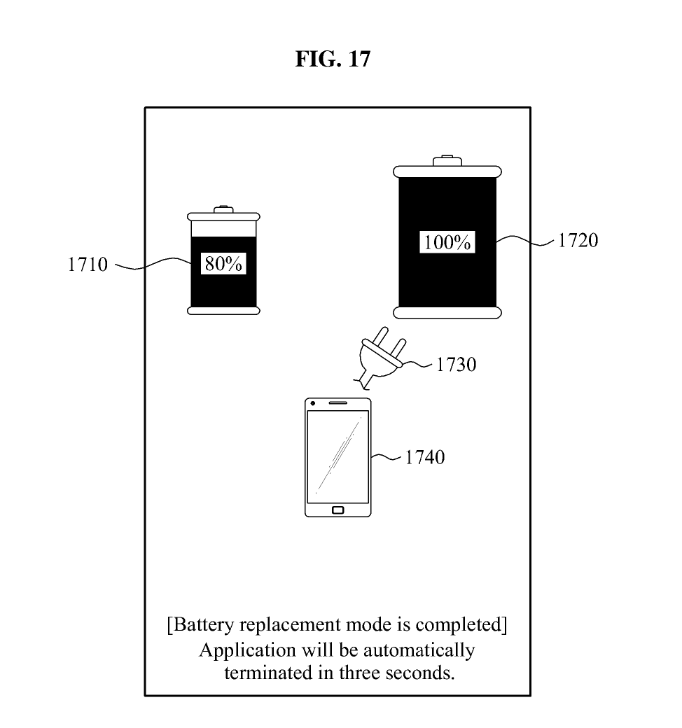

FIG. 15, FIG. 16, and FIG. 17 illustrate user interfaces displayed in a battery replacement mode of an apparatus to control a terminal having a multiple battery configuration according to exemplary embodiments of the present invention.

FIG. 15, FIG. 16, and FIG. 17 are exemplary user interfaces that may be displayed in setting of a battery replacement mode, operating of the battery replacement mode, and completion of the battery replacement mode, respectively.

Referring to FIG. 15, a power level of an auxiliary battery 1510 and a power level of a main battery 1520 may be displayed on a user interface. Also, an icon 1540 may indicate that the terminal is currently being supplied with power 1530 from the main battery 1520. Through a touch input of a setting icon of the battery replacement mode, the terminal may start a process of the battery replacement mode.

Referring to FIG. 16, the battery replacement mode operates, and an icon 1640 indicates that power 1630 is being supplied from an auxiliary battery 1610. A message and an icon for requesting replacement of a main battery 1620 may be displayed. Also, an icon labeled “cancel”, which is capable of initiating a cancellation of progress of the battery replacement mode, may be displayed.

Referring to FIG. 17, reinsertion of a main battery 1720 having sufficient charge after being separated may be displayed. Further, an icon 1740, which indicates that the terminal is being supplied with power 1730 from the main battery 1720, is also displayed. A power level of an auxiliary battery 1710 is displayed. When the battery replacement mode is completed, an application for executing the battery replacement mode maybe automatically terminated after a predetermined period of time.

According to exemplary embodiments, mute mode/airplane mode/end mode items may be included in a portable terminal as menu options. By adding a battery replacement mode to the above portable terminal menu options, a user access may be provided. Also, a mode setting portion may be configured using a separate application or a separate setting screen.

According to exemplary embodiments, when replacing a battery due to a decrease in charge of a main battery of a portable terminal, it may be possible to reduce a likelihood of cutting off power to the portable terminal by continuously supplying power from an auxiliary battery embedded within the portable terminal.

According to exemplary embodiments, a power system in which at least two batteries of a portable terminal are provided in parallel through a charge algorithm and a replacement algorithm of a small auxiliary battery based on a current limiting circuit and switch structure may be provided. Accordingly, it may be possible to increase stability of a battery cell. Also, even when replacing a main battery, power of the portable terminal may be maintained and thus, it may be possible to improve user inconvenience coming from rebooting.

According to exemplary embodiments, there may be provided an apparatus and method that may continuously supply power to a terminal using a main battery and an auxiliary even when replacing the main battery. Thus, an operation of the terminal may be prevented or limited from being suspended. Further, a predetermined amount of time to drive the terminal again may be reduced.

Also, according to exemplary embodiments, there may be provided an apparatus and method that may stably drive a main battery and an auxiliary battery using an overcurrent protection circuit to limit or prevent the occurrence of overcurrent that may occur when using the auxiliary battery having capacity different from the main battery.

Also, according to exemplary embodiments, there may be provided an apparatus and method that may charge an auxiliary battery from a main battery or an external charger by applying a charge control algorithm based on an amount of power stored in the main battery and the auxiliary battery and whether charge from the external charger is available.

The exemplary embodiments according to the present invention may be recorded in non-transitory computer-readable media including program instructions to implement various operations embodied by a computer. The media may also include, along with the program instructions, data files, data structures, and the like. The media and program instructions may be those specially designed and constructed, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a first battery to supply power to the terminal if a power level of the first battery is above a first reference threshold;
a second battery to supply power to the terminal if the power level of the first battery is below the first reference threshold; and
a switch to connect at least one of the first battery and the second battery to power the terminal based on the power level of the first battery,
wherein the first battery is detachable from the terminal.

2. The terminal of claim 1, further comprising:
a current limiter to limit a charge current of the second battery to be less than or equal to a second reference threshold, and to limit an output current of the second battery to be less than or equal to a reference discharge current value of the second battery.

3. The terminal of claim 2, wherein, if the first battery and the second battery are connected, the current limiter reduce an output current of the first battery to be less than or equal to a reference charge current value of the second battery.

4. The terminal of claim 1, wherein, if the first battery and the second battery are connected, the first battery charges the second battery.

5. The terminal of claim 1, wherein, if the first battery and the second battery are connected, the second battery charges the first battery.

6. The terminal of claim 1, further comprising:
a controller to limit at least one operation of the terminal if the terminal is powered by the second battery.

7. The terminal of claim 1, further comprising:
a storage to store setting values of one or more modules if a power level of the first battery decrease to be below the first reference threshold, and to restore the stored setting values if the power level of the first battery increase to be above the first reference threshold.

8. The terminal of claim 6, wherein the controller is configured to suspend an operation of a communication module, to decrease or turn off volume of a speaker module, to decrease or turn off a brightness value of a brightness module, and to suspend operations of a camera and a sensor module if the terminal is powered by the second battery.

9. The terminal of claim 1, wherein the switch connects the first battery and the second battery in parallel based on power level of the second battery.

10. A terminal, comprising:
a first battery to supply power to the terminal;
a second battery to supply power to the terminal if the first battery is separated from the terminal; and
a switch to connect the terminal to the second battery to power the terminal if the first battery is separated from the terminal.

11. The terminal of claim 10, further comprising:
a display to display a notification that the first battery can be separated from the terminal.

12. The terminal of claim 11, wherein the notification is displayed if a power level of the first battery is below a reference threshold.

13. The terminal of claim 10, wherein the first battery is separated from the terminal if a power level of the first battery is below a reference threshold.

14. The terminal of claim 13, wherein the switch reconnects the terminal to the first battery to power the terminal if the first battery having a power level above the reference threshold is reconnected to the terminal.

15. The terminal of claim 13, wherein the switch connects the terminal to a third battery having a power level above the reference threshold if the third battery is inserted into the terminal.

16. The terminal of claim 15, wherein the third battery connects to a same port that the first battery was connected to before the first battery was separated from the terminal.

17. The terminal of claim 10, further comprising:
a storage to store setting values of one or more modules if the terminal is powered by the first battery, and to restore the stored setting values if the first battery having a power level above the reference threshold is reconnected to the terminal.

18. A method for controlling a terminal having a multiple battery configuration, comprising:
determining whether a first battery is connected to the terminal;
determining whether the first battery has a power level below a reference threshold if the first battery is connected to the terminal; and
switching supply of power from the first battery to a second battery if the first battery is not connected to the terminal or determined to have a power level below the reference threshold.

19. The method of claim 18, wherein at least one operation of the terminal is limited if the terminal is powered by the second battery.

20. The method of claim 18, further comprising:
storing setting values of one or more modules corresponding to the terminal powered by the first battery; and
restoring the stored setting values if the first battery having a power level above the reference threshold is reconnected to the terminal after the first battery was separated or if the power level of the first battery increase to be above the reference threshold.
